(19) United States
(12) Patent Application Publication
(10) Pub. No.: US 2010/0110068 A1
(43) Pub. Date: May 6, 2010

(54) METHOD, APPARATUS, AND COMPUTER PROGRAM PRODUCT FOR GENERATING STEREOSCOPIC IMAGE

(76) Inventors: Yasunobu Yamauchi, Kanagawa (JP); Rieko Fukushima, Tokyo (JP); Kaoru Sugita, Saitama (JP); Yuzo Hirayama, Kanagawa (JP); Miwako Doi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/994,023

(22) PCT Filed: Sep. 21, 2007
(86) PCT No.: PCT/JP2007/069121

§ 371 Date: Dec. 27, 2007

(30) Foreign Application Priority Data
Oct. 2, 2006 (JP) 2006-271052

(51) Int. Cl. H04N 13/02; G06T 15/00

(52) U.S. Cl. 345/419; 348/54; 348/E13.075

(57) ABSTRACT

A detecting unit detects at least one of a position and a posture of a real object located on or near a three-dimensional display surface. A calculating unit calculates a masked-area where the real object masks a ray irradiated from the three-dimensional display surface, based on at least one of the position and the posture. A rendering unit renders a stereoscopic image by performing different rendering processes on the masked-area from rendering processes on other areas.

### TECHNICAL FIELD

The present invention relates to a technology for generating a stereoscopic image linked to a real object.

### BACKGROUND ART

Various methods have been used to realize a stereoscopic-image display apparatus, i.e., a so-called three-dimensional display apparatus, which displays a moving image. There is an increasing need for a flat-panel display apparatus that does not require stereoscopic glasses. There is a relatively easy method of providing a beam controller right in front of a display panel with fixed pixels such as a direct-view-type or projection-type liquid crystal display panel or plasma display panel, where the beam controller controls beams from the display panel to direct a viewer.

The beam controller is also referred to as a parallax barrier, which controls the beams so that different images are seen on a point on the beam controller depending on an angle. For example, to use only a horizontal parallax, a slit or a lenticular sheet that includes a cylindrical lens array is used as the beam controller. To use a vertical parallax at the same time, one of a pinhole array and a lens array is used as the beam controller.

A method that uses the parallax barrier is further classified into a bidirectional method, an omnidirectional method, a super omnidirectional method (a super omnidirectional condition of the omnidirectional method), and an integral photography (hereinafter, “IP method”). The methods use a basic principle substantially same as what was invented about a hundred years ago and has been used for stereoscopic photography.

Because a visual range is generally limited, both of the IP method and the multi-lens method generate an image so that a transparent projected image can be actually seen at the visual range. For example, as disclosed in JP-A 2004-295013 (KOKAI) and JP-A 2005-86414 (KOKAI), if a horizontal pitch of the parallax barrier is an integral multiplication of a horizontal pitch of the pixels when using a one-dimensional IP method that uses only the horizontal parallax, there are parallel rays (hereinafter, “parallel-ray one-dimensional IP”). Therefore, an accurate stereoscopic image is acquired by dividing an image with respect to each pixel array and synthesizing a parallax-synthesized image to be displayed on a screen, where the image before dividing is a perspective projection at a constant visual range in the vertical direction and a parallel projection in the horizontal direction.

In the omnidirectional method, the accurate stereoscopic image is acquired by dividing and arranging a simple perspective projection image.

It is difficult to realize an imaging device that uses different projection methods or different distances to a projection center between the vertical direction and the horizontal direction because it requires a camera or a lens with the size equal to a subject, especially for parallel projection. To acquire parallel projection data by imaging, it is realistic to convert the image from the imaging data of the perspective projection. For example, a ray-space method based on compensation using an epipolar plane (EPI) has been known.

To display a stereoscopic image by reproducing the beams, a three-dimensional display based on integral imaging method can reproduce a high-quality stereoscopic image by increasing amount of information of the beams to be reproduced. The information is, for example, the number of points of sight in the case of the omnidirectional method, or the number of the beams in different directions from a display plane in the case of the IP method.

However, the processing load of reproducing the stereoscopic image depends on the processing load of rendering from each point of sight, i.e., rendering in computer graphics (CG), and it increases in proportion to the number of the points of sight or the beams. Specifically to reproduce a voluminous image in three dimensions, it is required to render volume data that defines medium density that forms an object from each point of sight. Rendering the volume data generally requires excessive load of calculating because tracking beams, i.e., ray casting, and calculating an attenuation rate have to be performed on all of the volume elements.

Therefore, to render the volume data on the integral-imaging three-dimensional display, the processing load further increases in proportion to the increased number of the points of sight and the beams. Moreover, when a surface-level modeling such as a polygon is employed at the same time, a fast rendering method based on the polygon cannot be fully utilized because the processing speed is controlled by a rendering process based on a ray tracing method, and the total processing load in the image generation increases.

Fusion of a real object and a stereoscopic virtual object and an interaction system use a technology such as mixed reality (MR), augmented reality (AR), or virtual reality (VR). The technologies can be roughly classified into two groups; the MR and the AR that superposes a virtual image created by CG on a real image, and the VR that inserts a real object into a virtual world created by CG as in cave automatic virtual equipment.

By reproducing a CG virtual space using a bidirectional stereo method, a CG-reproduced virtual object can be produced in a three-dimensional position and posture as in the real world. In other words, the real object and the virtual object can be displayed in corresponding position and posture; however, the image needs to be configured every time the point of sight of a user changes. Moreover, to reproduce visual reality that depends on the point of sight of the user, a tracking system is required to detect the position and the posture of the user.

### DISCLOSURE OF INVENTION

An apparatus for generating a stereoscopic image, according to one aspect of the present invention, includes a detecting unit that detects at least one of a position and a posture of a real object located on or near a three-dimensional display surface; a calculating unit that calculates a masked-area where the real object masks a ray irradiated from the three-dimensional display surface, based on at least one of the position and the posture; and a rendering unit that renders a stereoscopic image by performing different rendering processes on the masked-area from rendering processes on other areas.

A method of generating a stereoscopic image, according to another aspect of the present invention, includes detecting at least one of a position and a posture of a real object located on or near a three-dimensional display surface; calculating a masked-area where the real object masks a ray irradiated from the three-dimensional display surface, based on at least one of the position and the posture; and rendering a stereoscopic image by performing different rendering processes on the masked-area from rendering processes on other areas.

A computer program product according to still another aspect of the present invention includes a computer-usable medium having computer-readable program codes embodied in the medium that when executed cause a computer to execute detecting at least one of a position and a posture of a real object located on or near a three-dimensional display surface; calculating a masked-area where the real object masks a ray irradiated from the three-dimensional display surface, based on at least one of the position and the posture; and rendering a stereoscopic image by performing different rendering processes on the masked-area from rendering processes on other areas.

### BRIEF DESCRIPTION OF DRAWINGS

FIG. 1 is a block diagram of a stereoscopic display apparatus according to a first embodiment of the present invention;

FIG. 2 is an enlarged perspective view of a display panel of the stereoscopic display apparatus;

FIG. 3 is a schematic diagram of parallax component images and a parallax-synthesized image in an omnidirectional stereoscopic display apparatus;

FIG. 4 is a schematic diagram of the parallax component images and a parallax-synthesized image in a stereoscopic display apparatus based on one-dimensional IP method;

FIGS. 5 and 6 are schematic diagrams of parallax images when a point of sight of a user changes;

FIG. 7 is a schematic diagram of a state where a transparent cup is placed on the display panel of the stereoscopic display apparatus;

FIG. 8 is a schematic diagram of hardware in a real-object position/posture detecting unit shown in FIG. 1;

FIG. 9 is a flowchart of a stereoscopic-image generating process according to the first embodiment;

FIG. 10 is an example of an image of the transparent cup with visual reality;

FIG. 11 is an example of drawing a periphery of the real object as volume data;

FIG. 12 is an example of drawing an internal concave of a cylindrical real object as volume data;

FIG. 13 is an example of drawing virtual goldfish autonomously swimming in the internal concave of the cylindrical real object;

FIG. 14 is a function block diagram of a stereoscopic display apparatus according to a second embodiment of the present invention;

FIG. 15 is a flowchart of a stereoscopic-image generating process according to the second embodiment;

FIG. 16 is a schematic diagram of a point of sight, a flat-laid stereoscopic display panel, and a real object seen from 60-degree upward;

FIG. 17 is a schematic diagram of spherical coordinate used to perform texture mapping that depends on positions of the point of sight and a light source;

FIG. 18 is, a schematic diagram of a vector U and a vector V in a projected coordinate system;

FIGS. 19A and 19B are schematic diagrams of a relative direction θ in a longitudinal direction;

FIG. 20 is a schematic diagram of the visual reality when a tomato bomb hits and crashes on the real transparent cup;

FIG. 21 is a schematic diagram of the flat-laid stereoscopic display panel and a plate;

FIG. 22 is a schematic diagram of the flat-laid stereoscopic display panel, the plate, and a cylindrical object; and

FIG. 23 is a schematic diagram of linear markers on both ends of the plate to detect a shape and a posture of the plate.

### BEST MODE(S) FOR CARRYING OUT THE INVENTION

Exemplary embodiments of the present invention are explained in detail below with reference to the accompanying drawings.

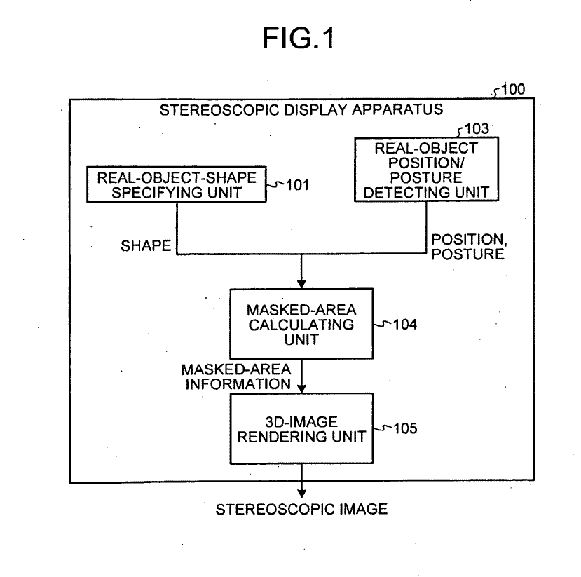

As shown in FIG. 1, a stereoscopic display apparatus 100 includes a real-object-shape specifying unit 101, a real-object position/posture detecting unit 103, a masked-area calculating unit 104, and a 3D-image rendering unit 105. The stereoscopic display apparatus 100 further includes hardware such as a stereoscopic display panel, a memory, and a central processing unit (CPU).

The real-object position/posture detecting unit 103 detects at least one of a position, a posture, and a shape of a real object on or near the stereoscopic display panel. A configuration of the real-object position/posture detecting unit 103 will be explained later in detail.

The real-object-shape specifying unit 101 receives the shape of the real object as specified by a user.

The masked-area calculating unit 104 calculates a masked-area where the real object masks a ray irradiated from the stereoscopic display panel based on the shape received by the masked-area calculating unit 104 and at least one of the position, the posture, and the shape detected by the real-object position/posture detecting unit 103.

The 3D-image rendering unit 105 performs rendering process on the masked-area calculated by the masked-area calculating unit 104 in a different manner from a manner used in other areas (Namely, the 3D-image rendering unit 105 performs different rendering processes on the masked-area calculated by the masked-area calculating unit 104 from rendering processes on other areas), generates a parallax-synthesized image, thereby renders a stereoscopic image, and outputs it. According to the first embodiment, the 3D-image rendering unit 105 renders the stereoscopic image on the masked-area as volume data that includes points in a three-dimensional space.

A method of generating an image on the stereoscopic display panel of the stereoscopic display apparatus 100 according to the first embodiment is explained below. The stereoscopic display apparatus 100 is designed to reproduce beams with n parallaxes. The explanation is given assuming that n is nine.

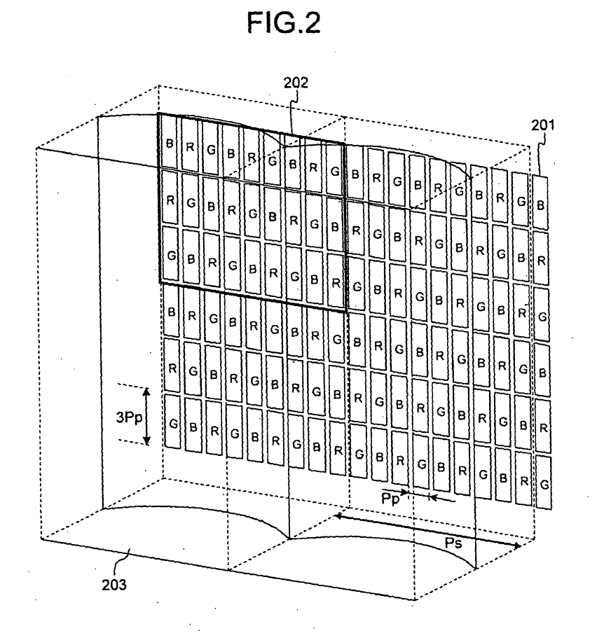

As shown in FIG. 2, the stereoscopic display apparatus 100 includes lenticular plates 20.3 arranged in front of a screen of a flat parallax-image display unit such as a liquid crystal panel. Each of the lenticular plates 203 includes cylindrical lenses with an optical aperture thereof vertically extending, which are used as beam controllers. Because the optical aperture extends linearly in the vertical direction and not obliquely or in a staircase pattern, pixels are easily arranged in a square array to display a stereoscopic image.

On the screen, pixels 201 with the vertical to horizontal ratio of 3:1 are arranged linearly in a lateral direction so that red (R), green (G), and blue (B) are alternately arranged in each row and each column. A longitudinal cycle of the pixels 201 (3Pp shown in FIG. 2) is three times of a lateral cycle of the pixels 201 (Pp shown in FIG. 2).

In a color image display apparatus that displays a color image, three pixels 201 of R, G, and B form one effective pixel, i.e., a minimum unit to set brightness and color. Each of R, G, and B is generally referred to as a sub-pixel.

A display panel shown in FIG. 2 includes a single effective pixel 202 consisting of nine columns and three rows of the pixels 201 as surrounded by a black border. The cylindrical lens of the lenticular plate 203 is arranged substantially in front of the effective pixel 202.

Based on one-dimensional integral photography (IP method) using parallel beams, the lenticular plate 203 reproduces parallel beams from every ninth pixel in each row on the display panel. The lenticular plate 203 functions as a beam controller that includes cylindrical lenses linearly extending at a horizontal pitch (Ps shown in FIG. 2) nine times as much as the lateral cycle of the sub-pixels.

Because the point of sight is actually set at a limited distance from the screen, the number of parallax component images is nine or more. The parallax component image includes image data of a set of pixels that form the parallel beams in the same parallax direction required to form an image by the stereoscopic display apparatus 100. By the beams to be actually used being extracted from the parallax component image, the parallax-synthesized image to be displayed on the stereoscopic display apparatus 100 is generated.

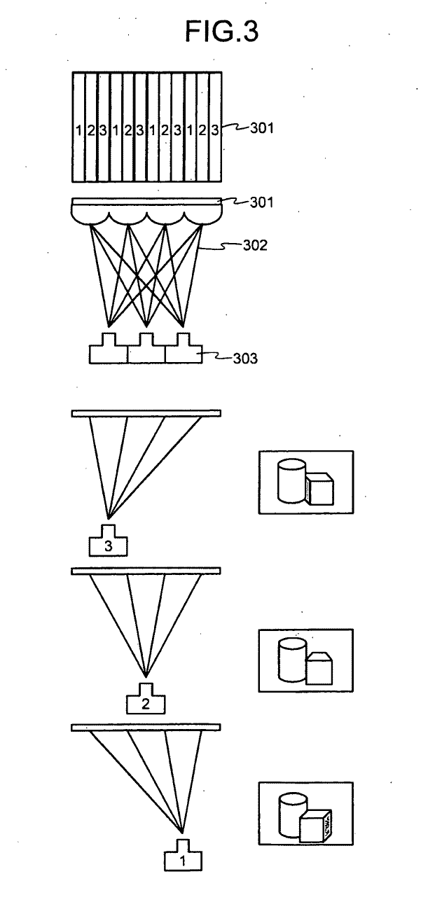

A relation between the parallax component images and the parallax-synthesized image on the screen in an omnidirectional stereoscopic display apparatus is shown in FIG. 3. Images used to display the stereoscopic image are denoted by 301, positions at which the images are acquired are denoted by 303, and segments between the center of the parallax images and exit apertures at the positions are denoted by 302.

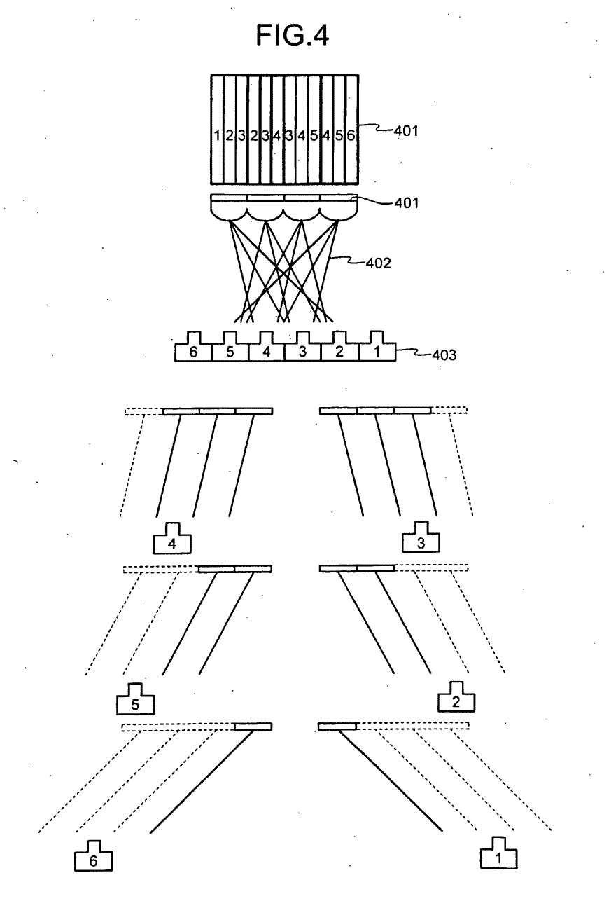

A relation between the parallax component images and the parallax-synthesized image on the screen in a one-dimensional IP stereoscopic display apparatus is shown in FIG. 4. The images used to display the stereoscopic image are denoted by 401, the positions at which the images are acquired are denoted by 403, and the segments between the center of the parallax images and exit apertures at the positions are denoted by 402.

The one-dimensional IP stereoscopic display apparatus acquires the images using a plurality of cameras disposed at a predetermined visual range from the screen, or performs rendering in computer graphics, where the number of the cameras is equal to or more than the number of the parallaxes of the stereoscopic display apparatus, and extracts beams required for the stereoscopic display apparatus from the rendered images.

The number of the beams extracted from each of the parallax component images depends on an assumed visual range in addition to the size and the resolution of the screen of the stereoscopic display apparatus. A component pixel width determined by the assumed visual range, which is slightly larger than nine pixel width, can be calculated using a method disclosed in JP-A 2004-295013 (KOKAI) or JP-A 2005-86414 (KOKAI).

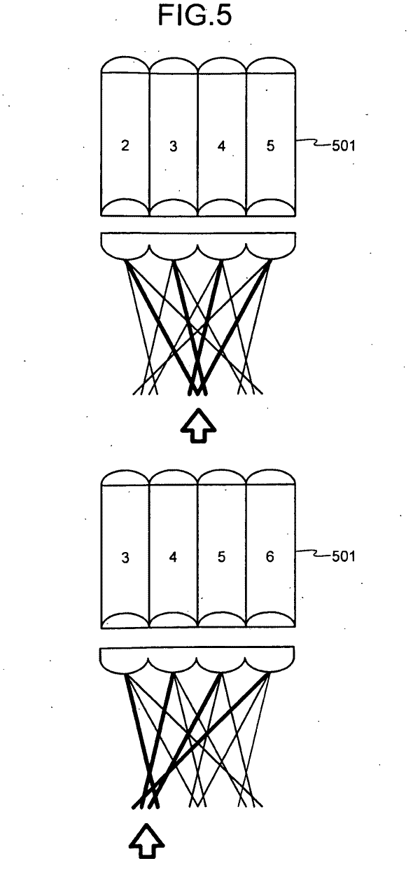

As shown in FIGS. 5 and 6, if the visual range changes, the parallax image seen from an observation point also changes. The parallax images seen from the observation points are denoted by 501 and 601.

Each of the parallax component images is generally perspectively projected at the assumed visual range or an equivalent thereof in the vertical direction and also parallelly projected in the horizontal direction. However, it can be perspectively projected in both the vertical direction and the horizontal direction. In other words, to generate an image in the stereoscopic display apparatus based on an integral imaging method, the imaging process or the rendering process can be performed by a necessary number of the cameras as long as the image can be converted into information of the beams to be reproduced.

The following explanation of the stereoscopic display apparatus 100 according to the first embodiment is given assuming that the number and the positions of the cameras that acquire the beams enough and necessary to display the stereoscopic image has been calculated.

Details of the real-object position/posture detecting unit 103 are explained below. The explanation is given based on the process of generating the stereoscopic image linked to a transparent cup used as the real object. In this case, actions of virtual penguins stereoscopically displayed on a flat-laid stereoscopic display panel are controlled by covering them with the real transparent cup. The virtual penguins move autonomously on the flat-laid stereoscopic display panel while shooting tomato bombs. The user covers the penguins with the transparent cup so that the tomato bombs hit the transparent cup and will not fall on the screen.

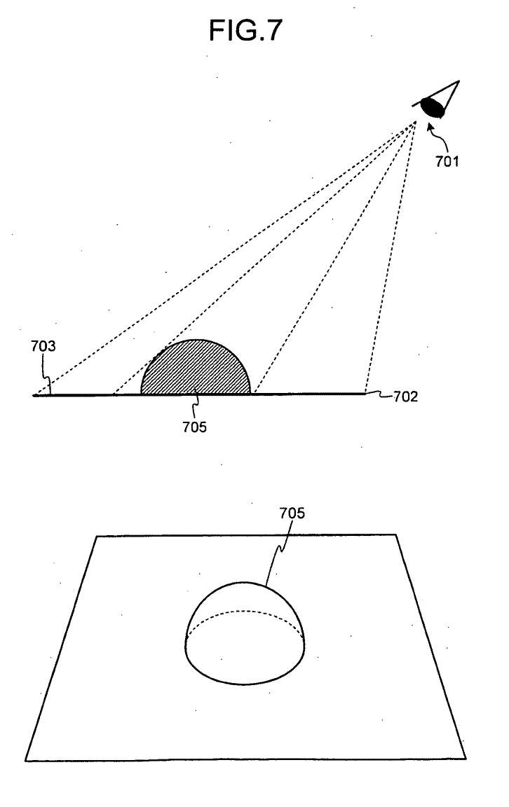

As shown in FIG. 8, the real-object position/posture detecting unit 103 includes infrared emitting units L and R, recursive sheets (not shown), and area image sensors L and R. The infrared emitting units L and R are provided at the upper-left and the upper-right of a screen 703. The recursive sheets are provided on the left and the right sides of the screen 703 and under the screen 703, reflecting infrared lights. The area image sensors L and R are provided at the same positions of the infrared emitting units L and R at the upper-left and the upper-right of the screen 703, and they receive the infrared lights reflected by the recursive sheets.

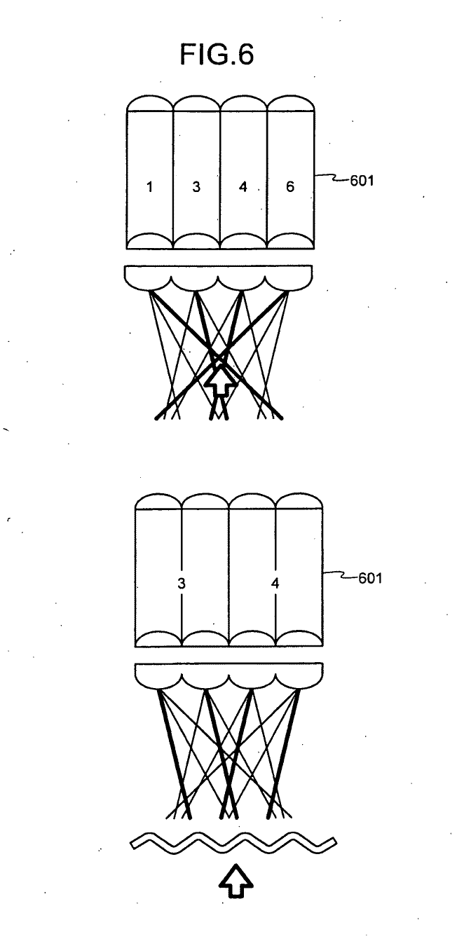

As shown in FIG. 7, to detect the position of a transparent cup 705 on the screen 703 of a stereoscopic display panel 702, each of areas 802 and 803 where the infrared light emitted from the infrared emitting unit L or R is masked by the transparent cup 705 so as not to be reflected by the recursive sheet and to reach none of the area image sensors L and R is measured. A reference numeral 701 in FIG. 7 denotes a point of sight.

In this manner, the center position of the transparent cup 705 is calculated. The real-object position/posture detecting unit 103 can detect only a real object within a certain height from the screen 703. However, the height area in which the real object is detected can be increased by using results of detection by the infrared emitting units L and R, the area image sensors L and R, and the recursive sheets arranged in layers above the screen 703. Otherwise, by applying a frosting marker 801 on the surface of the transparent cup 705 at the same height as the infrared emitting units L and R, the area image sensors L and R, and the recursive sheets as shown in FIG. 8, the accuracy of the detection by the area image sensors L and R is increased while taking advantage of the transparency of the cup.

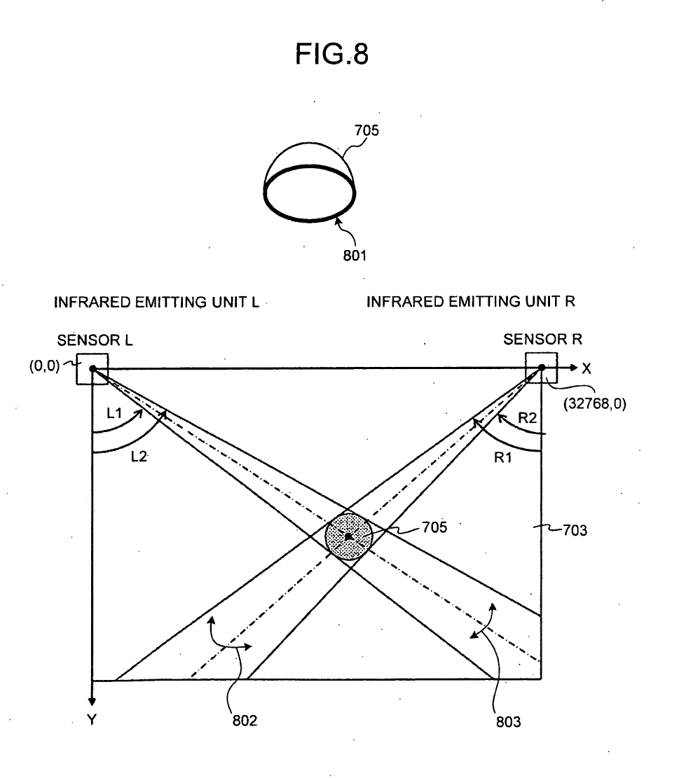

A stereoscopic-image generating process performed by the stereoscopic display apparatus 100 is explained referring to FIG. 9.

The real-object position/posture detecting unit 103 detects the position and the posture of the real object in the manner described above (step S1). At the same time, the real-object-shape specifying unit 101 receives the shape of the real object as specified by a user (step S2).

For example, if the real object is the transparent cup 705, the user specifies the three-dimensional shape of the transparent cup 705, which is a hemisphere, and the real-object-shape specifying unit 101 receives the specified three-dimensional shape. By matching the three-dimensional scale of the screen 703, the transparent cup 705, and the virtual object in a virtual scene with the actual size of the screen 703, the position and the posture of the real transparent cup and those of the cup displayed as the virtual object match.

The masked-area calculating unit 104 calculates the masked-area. More specifically, the masked-area calculating unit 104 detects a two-dimensional masked-area (step S3). In other words, the two-dimensional masked-area masked by the real object when seen from the point of sight 701 of a camera is detected by rendering only the real object received by the real-object-shape specifying unit 101.

An area of the real object in a rendered image is the two-dimensional masked-area seen from the point of sight 701. Because the pixels in the masked-area correspond to the light emitted from the stereoscopic display panel 702, the detection of the two-dimensional masked-area is to distinguish the information of the beams masked by the real object from the information of those not masked among the beams emitted from the screen 703.

The masked-area calculating unit 104 calculates the masked-area in the depth direction (step S4). The masked-area in the depth direction is calculated as described below.

A Z-buffer corresponding to a distance from the point of sight 701 to a plane closer to the camera is considered to be the distance between the camera and the real object. The Z-buffer is stored in a buffer with the same size as a frame buffer as real-object front-depth information Zobj_front.

Whether the real object is in front of or at the back of the camera is determined by calculating an inner product of a vector from the point of sight to a focused polygon and a polygon normal. If the inner product is positive, the polygon faces forward, and if the inner product is negative, the polygon faces backward. Similarly, a Z-buffer corresponding to a distance from the point of sight 701 to a plane in the back of the point of sight is considered to be the distance between the point of sight and the real object. The Z-buffer at the time of the rendering is stored in the memory as real-object back-depth information Zobj_back.

The masked-area calculating unit 104 renders only objects included in a scene. A pixel value after the rendering is herein referred to as Cscene. The Z-buffer corresponding to the distance from the visual point is stored in the memory as virtual-object depth information Zscene. The masked-area calculating unit 104 renders a rectangular area that corresponds to the screen 703, and stores the result of the rendering in the memory as display depth information Zdisp. The closest Z value among Zobj_back, Zdisp, and Zscene is considered as an edge of the masked-area Zfar. A vector Zv indicative of an area in the depth direction finally masked by the real object and the screen 703 is calculated by

Zv=Zobj_front−Zfar (1)

The area in the depth direction is calculated with respect to each pixel in the two-dimensional masked-area from the point of sight.

The 3D-image rendering unit 105 determines whether the pixel is included in the masked-area (step S5). If it is included in the masked-area (YES at step S5), the 3D-image rendering unit 105 renders the pixel in the masked-area as a volume data by performing a volumetric rendering (step S6). The volumetric rendering is performed by calculating a final pixel value Cfinal to be determined taking into account the effect on the masked-area using Equation (2).

Cfinal=Cscene*α*(Cv*Zv) (2)

The symbol “*” indicates multiplication. Cv is color information including vectors of R, G, and B used to express the volume of the masked-area, and α is a parameter, i.e., a scalar, used to normalize the Z-buffer and adjust the volume data.

If the pixel is not included in the masked-area (NO at step S5), the volumetric rendering is not performed. As a result, different rendering processes are performed on the masked-areas and other areas.

The 3D-image rendering unit 105 determines whether the process at the steps S3 to S6 has been performed on all of points of sight of the camera (step S7). If the process has not been performed on all the points of sight (NO at step S7), the stereoscopic display apparatus 100 repeats the steps S3 to S7 on the next point of sight.

If the process has been performed on all of the points of sight (YES at step S7), the 3D-image rendering unit 105 generates the stereoscopic image by converting the rendering result into the parallax-synthesized image (step S8).

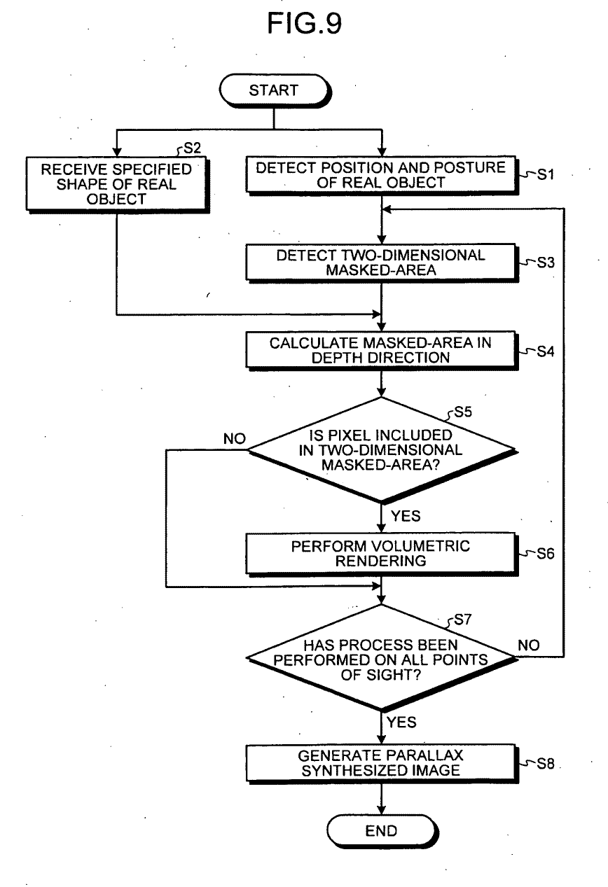

By performing the above-described process, for example, if the real object is the transparent cup 705 disposed on the screen, the internal of the cup is converted into a volume image that includes certain colors, whereby the presence of the cup and the state inside the cup are more easily recognized. When a volume effect is applied to the transparent cup, it is applied to the area masked by the transparent cup, as indicated by 1001 shown in FIG. 10.

If it is an only purpose to apply visual reality to the three-dimensional area of the transparent cup, detection of the masked-area in the depth direction does not have to be performed with respect to each pixel in the two-dimensional masked-area of the image from each point of sight. Instead, the stereoscopic display apparatus 100 can be configured to render the masked-area with the volume effect by accumulating the colors that express the volume effect after rendering the scenes that include virtual objects.

Although the 3D-image rendering unit 105 renders the area masked by the real object as the volume data to apply the volume effect in the first embodiment, the 3D-image rendering unit 105 can be configured to render the area around the real object as the volume data.

To do so, the 3D-image rendering unit 105 enlarges the shape of the real object received by the real-object-shape specifying unit 101 in three dimensions, and the enlarged shape is used as the shape of the real object. By rendering the enlarged area as the volume data, the 3D-image rendering unit 105 applies the volume effect to the periphery of the real object.

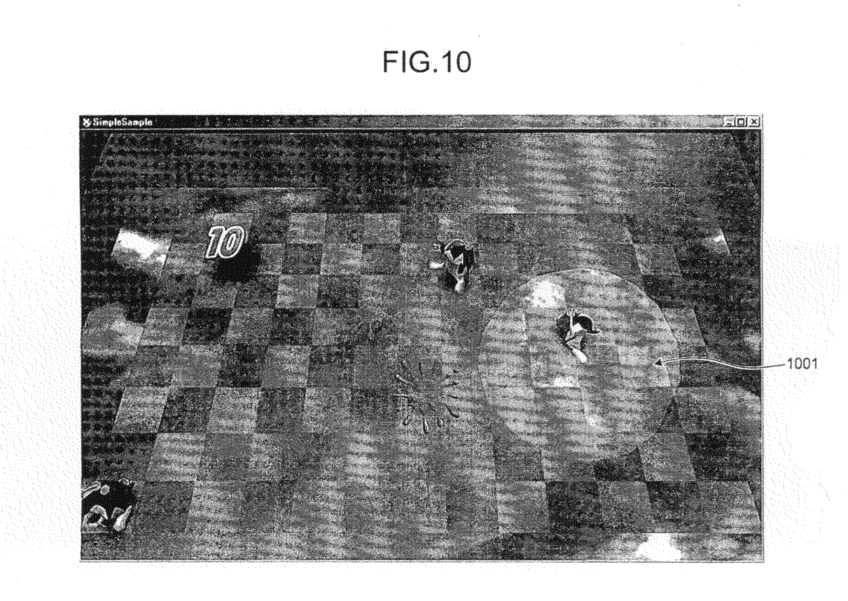

For example, to render the periphery of the transparent cup 705 as the volume data, as shown in FIG. 11, the shape of the transparent cup is enlarged in three dimensions, and a peripheral area 1101 enlarged from the transparent cup is rendered as the volume data.

The 3D-image rendering unit 10.5 can be configured to use a cylindrical real object and render an internal concave of the real object as the volume data. In this case, the real-object-shape specifying unit 101 receives the specification of the shape as a cylinder with a closed top and closed bottom, the top being lower than the full height of the cylinder. The 3D-image rendering unit 105 renders the internal concave of the cylinder as the volume data.

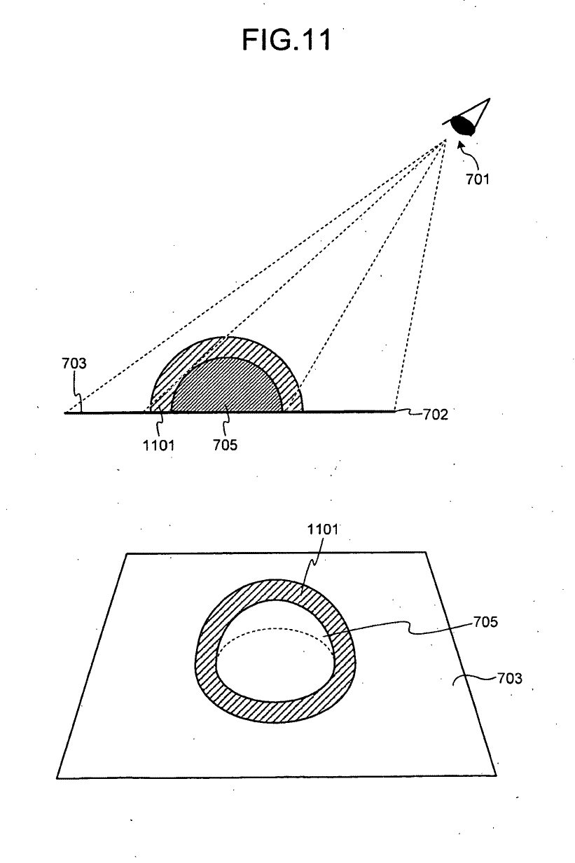

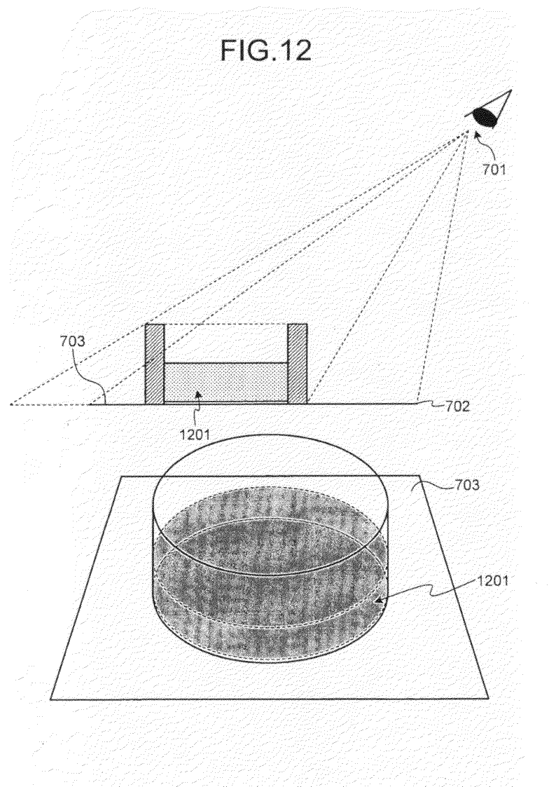

To render the internal concave of the cylindrical real object as the volume data, for example, as shown in FIG. 12, the fullness of water is visualized by rendering an internal concave 1201 as the volume data. Moreover, by rendering virtual goldfish autonomously swimming in the concave internal of the cylinder as shown in FIG. 13, the user recognizes by sight that the goldfish are present in a cylindrical aquarium that contains water.

As described above, the stereoscopic display apparatus 100 based on the integral imaging method according to the first embodiment specifies a spatial area to be focused on using the real object, and efficiently creates the visual reality independent from the point of sight of the user. Therefore, a stereoscopic image that changes depending on the position, the posture, and the shape of the real object is generated without using a tracking system that tracks actions of the user, and efficiently generates a voluminous stereoscopic image with reduced amount of process.

A stereoscopic display apparatus 1400 according to a second embodiment of the present invention further receives an attribute of the real object and performs the rendering process on the masked-area based on the received attribute.

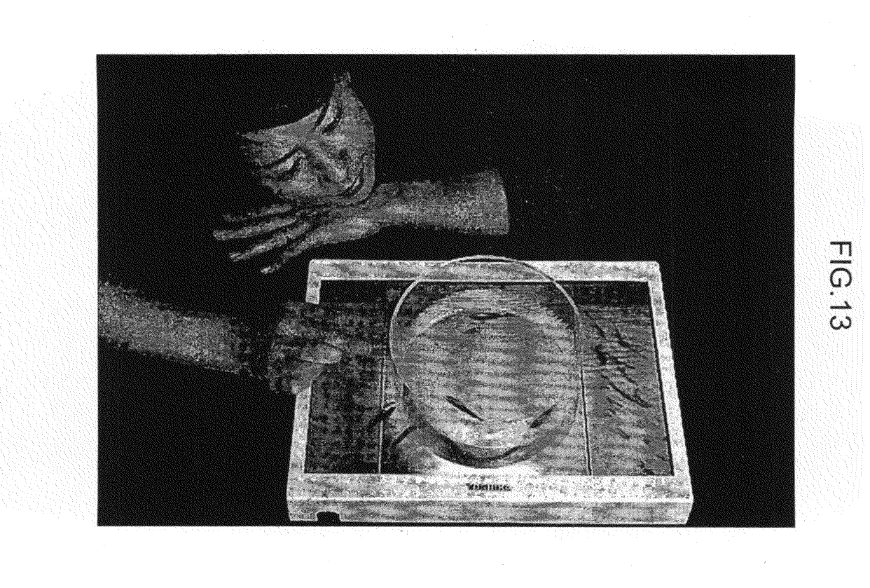

As shown in FIG. 14, the stereoscopic display apparatus 1400 includes the real-object-shape specifying unit 101, the real-object position/posture detecting unit 103, the masked-area calculating unit 104, a 3D-image rendering unit 1405, and a real-object-attribute specifying unit 1406. Moreover, the stereoscopic display apparatus 1400 includes hardware such as the stereoscopic display panel, the memory, and the CPU.

The functions and the configurations of the real-object-shape specifying unit 101, the real-object position/posture detecting unit 103, and the masked-area calculating unit 104 are same as those in the stereoscopic display apparatus 100 according to the first embodiment.

The real-object-attribute specifying unit 1406 receives at least one of thickness, transmittance, and color of the real object as the attribute.

The 3D-image rendering unit 1405 generates the parallax-synthesized image by applying surface effect to the masked-area based on the shape received by the real-object-shape specifying unit 101 the attribute of the real object received by the real-object-attribute specifying unit 1406.

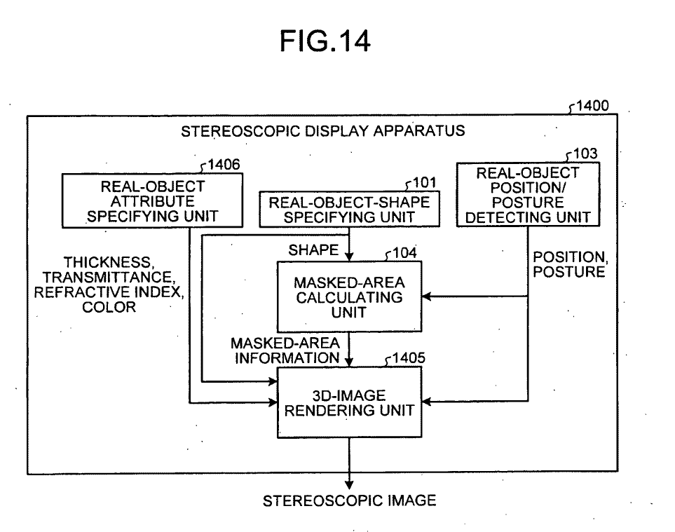

A stereoscopic-image generating process performed by the stereoscopic display apparatus 1400 is explained referring to FIG. 15. Steps S11 to S14 are same as the steps S1 to S4 shown in FIG. 9.

According to the second embodiment, the real-object-attribute specifying unit 1406 receives the thickness, the transmittance, and/or the color of the real object specified by the user as the attribute (step S16). The 3D-image rendering unit 1405 determines whether the pixel is included in the masked-area (step S15). If it is included in the masked-area (YES at step S15), the 3D-image rendering unit 1405 performs a rendering process that applies the surface effect to the pixel in the masked-area by referring to the attribute and the shape of the real object (step S17).

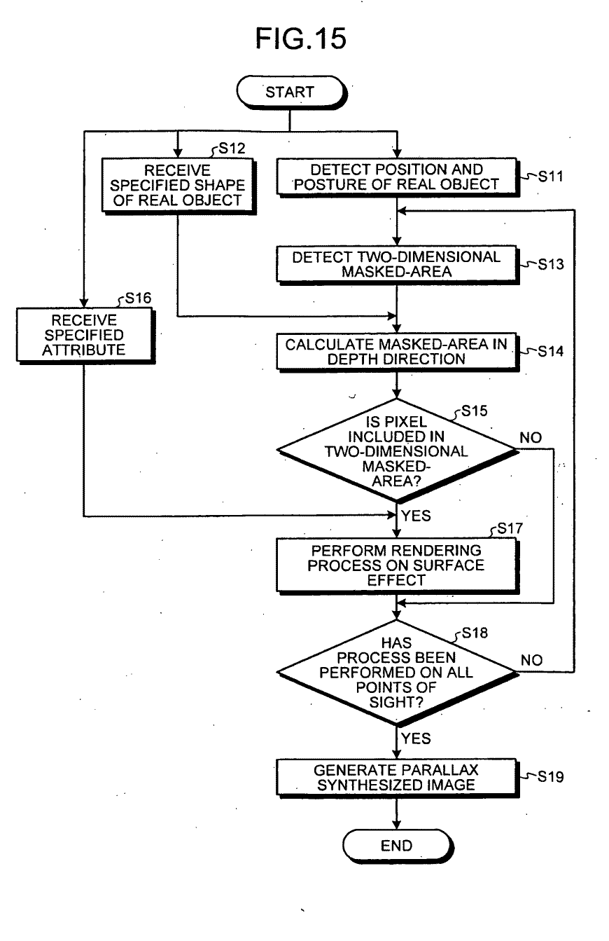

The information of the pixels masked by the real object from each point of sight is detected in the detection of the two-dimensional masked-area at the step S13. One-to-one correspondence between each pixel and the information of the beam is uniquely determined by the relation between the position of the camera and the screen. Positional relation among the point of sight 701 that looks at the flat-laid stereoscopic display panel 702 from 60 degrees upward, the screen 703, and a real object 1505 that masks the screen is shown in FIG. 16.

The rendering process on the surface effect applies an effect on an interaction with the real object with respect to each beam that corresponds to each pixel detected at the step S13. More specifically, a pixel value of the image from the point of sight finally determined taking into account the surface effect of the real object Cresult is calculated by

Cresult=Cscene*Cobj*β*(dobj*(2.0−Nobj·Vcam)) (3)

The symbol “*” indicates the multiplication, and the symbol “•” indicates the inner product. Cscene is the pixel value of the rendering result excluding the real object; Cobj is the color of the real object received by the real-object-attribute specifying unit 1406 (vectors of R, G, and B); dobj is the thickness of the real object received by the real-object-attribute specifying unit 1406; Nobj is a normalized normal vector on the surface of the real object; Vcam is a normalized normal vector directed from the point of sight 701 of the camera to the surface of the real object; and β is a coefficient that determines a degree of the visual reality.

Because Vcam is equivalent to a beam vector, it can apply the visual reality taking into account the attribute of the surface of the real object, such as the thickness, to the light entering obliquely to the surface of the real object. As a result, it is more emphasized that the real object is transparent and has the thickness.

To render roughness of the surface of the real object, the real-object-attribute specifying unit 1406 specifies map information such as a bump map or a normal map as the attribute of the real object, and the 3D-image rendering unit 1405 efficiently controls the normalized normal vector on the surface of the real object at the time of the rendering process.

The information on the point of sight of the camera is determined by only the stereoscopic display panel 702 independently of the state of the user, and therefore the surface effect of the real object dependent on the point of sight is rendered as the stereoscopic image regardless of the point of sight of the user.

For example, the 3D-image rendering unit 1405 creates a highlight to apply the surface effect to the real object. The highlight on the surface of a metal or transparent object changes depending on the point of sight. The highlight can be realized in units of the beam by calculating Cresult based on Nobj and Vcam.

The 3D-image rendering unit 1405 defocuses the shape of the highlight by superposing the stereoscopic image on the highlight present on the real object to show the real object as if it is made of a different material. The 3D-image rendering unit 1405 visualizes a virtual light source and an environment by superposing a highlight that is not actually present on the real object as the stereoscopic image.

Moreover, the 3D-image rendering unit 1405 synthesizes a virtual crack that is not actually present on the real object as the stereoscopic image. For example, if a real glass with a certain thickness cracks, the crack looks differently depending on the point of sight. The color information generated by the effect of the crack Ceffect is calculated using Equation (4) to apply the visual reality of the crack to the masked-area.

Ceffect=γ*Ccrack*|Vcam×Vcrack (4)

The symbol “*” indicates the multiplication, and the symbol “x” indicates exterior product. By synthesizing Ceffect with the pixel on the image from the point of sight, the final pixel information that includes the crack is generated. Ccrack is a color value used for the visual reality of the crack; Vcam is the normalized normal vector directed from the point of sight of the camera to the surface of the real object; Vcrack is a normalized crack-direction vector indicative of the direction of the crack; and γ is a parameter used to adjust the degree of the visual reality.

Furthermore, to show an image of the tomato bomb hit and crashed against the real transparent cup, the visual reality is reproduced on the stereoscopic display panel by using a texture mapping method, which uses the crashed tomato bomb as a texture.

The texture mapping method is explained below. The 3D-image rendering unit 1405 performs mapping by switching texture images based on a bidirectional texture function (BTF) that indicates a texture element on the surface of the polygon depending on the point of sight and the light source.

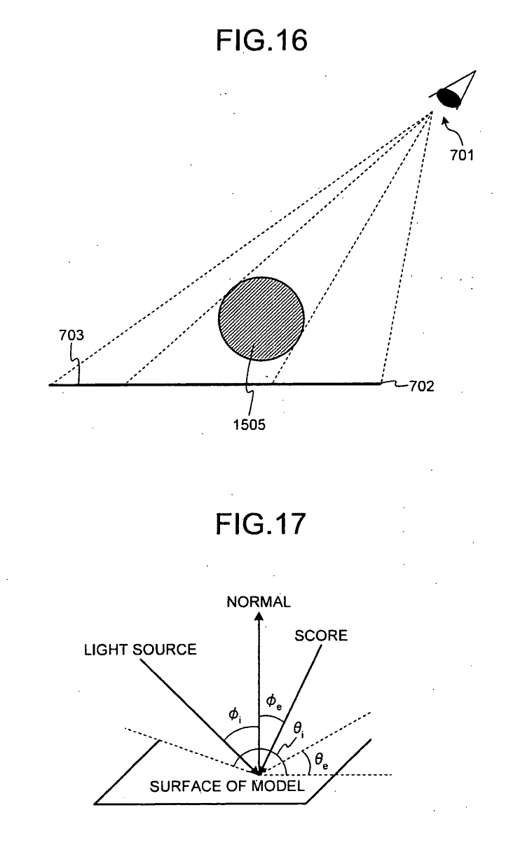

The BTF uses a spherical coordinate system with its origin at the image subject on the surface of the model shown in FIG. 17 to specify the positions of the point of sight and the light source. FIG. 17 is a schematic diagram of the spherical coordinate system used to perform the texture mapping that depends on positions of the point of sight and the light source.

Assuming that the point of sight is infinitely far and the light from the light source is parallel, the coordinate of the point of sight is (θe, φe) and the coordinate of the light source is (θi, φi), where θe and θi indicate longitudinal angles, and φe and φi indicate latitudinal angles. In this case, a texture address is defined in six dimensions. For example, a texel is indicated using six variables as described below

T(θe,θi,φi,u,v) (5)

Each of u and v indicates an address in the texture. In fact, a plurality of texture images acquired at a specific point of sight and a specific light source is accumulated, and the texture is expressed by switching the textures and combining the addresses in the texture. Mapping of the texture in this manner is referred to as a high-dimensional texture mapping.

The 3D-image rendering unit 1405 performs the texture mapping as described below. The 3D-image rendering unit 1405 specifies model shape data and divides the model shape data into rendering primitives. In other words, the 3D-image rendering unit 1405 divides the model shape data into units of the image processing, which is generally performed in units of polygons consisting three points. The polygon is planar information surrounded by the three points, and the 3D-image rendering unit 1405 performs the rendering process on the internal of the polygon.

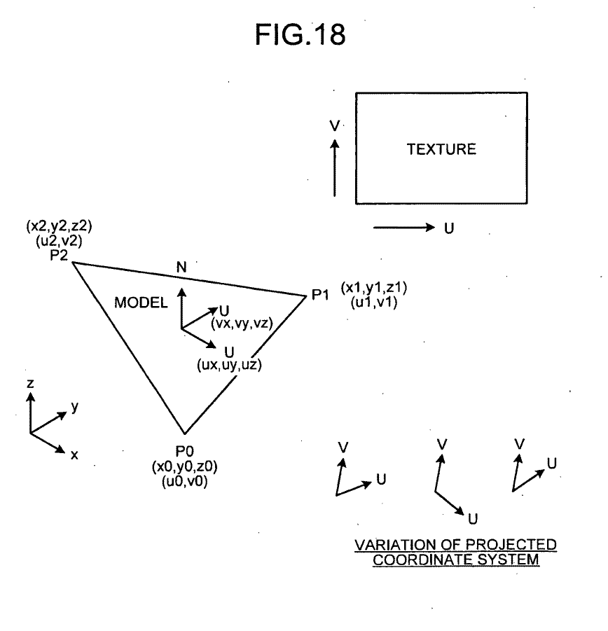

The 3D-image rendering unit 1405 calculates a texture-projected coordinate of a rendering primitive. In other words, the 3D-image rendering unit 1405 calculates a vector U and a vector V on the projected coordinate when a u-axis and a v-axis in a two-dimensional coordinate system that define the texture are projected onto a plane defined by the three points indicated by a three-dimensional coordinate in the rendering primitive. The 3D-image rendering unit 1405 calculates the normal to the plane defined by the three points. A method for calculating the vector U and the vector V will be explained later referring to FIG. 18.

The 3D-image rendering unit 1405 specifies the vector U, the vector V, the normal, the position of the point of sight, and the position of the light source, and calculates the directions of the point of sight and the light source (direction parameters) to acquire relative directions of the point of sight and the light source to the rendering primitive.

More specifically, the latitudinal relative direction φ is calculated from a normal vector N and a direction vector D by

φ=arccos (D·N/(|D|*|N|)) (6)

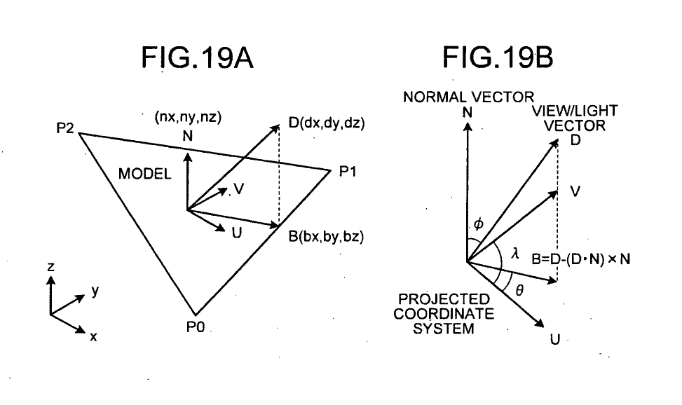

D·N is an inner product of the vector D and the vector N; and the symbol “*” indicates the multiplication. A method for calculating a longitudinal relative direction θ will be explained later referring to FIGS. 19A and 19B.

The 3D-image rendering unit 1405 generates a rendering texture based on the relative directions of the point of sight and the light source. The rendering texture to be pasted on the rendering primitive is prepared in advance. The 3D-image rendering unit 1405 acquires texel information from the texture in the memory based on the relative directions of the point of sight and the light source. Acquiring the texel information means assigning the texture element acquired under a specific condition to a texture coordinate space that corresponds to the rendering primitive. The acquisition of the relative direction and the texture element can be performed with respect to each point of sight or each light source, and they are acquired in the same manner if there is a plurality of point of sights and light sources.

The 3D-image rendering unit 1405 performs the process on all of the rendering primitives. After all of the primitives are processed, the 3D-image rendering unit 1405 maps each of the rendered textures to a corresponding point on the model.

The method for calculating the vector U and the vector V is explained referring to FIG. 18.

The three-dimensional coordinates and the texture coordinates of the three points that define the rendering primitive are described as follows.

Point P0: three-dimensional coordinate (x0, y0, z0), texture coordinate (u0, v0)

Point P1: three-dimensional coordinate (x1, y1, z1), texture coordinate (u1, v1)

Point P2: three-dimensional coordinate (x2, y2, z2), texture coordinate (u2, v2)

By defining the coordinates as described above, the vector U=(ux, uy, uz) and the vector V=(vx, vy, vz) in the projected coordinate system are calculated by

P2−P0=(u1−u0)*U+(v1−v0)*V

P1−P0=(u2−u0)*U+(v2−v0)*V

Based on the three-dimensional coordinates of P0, P1, and P2, the vector U and the vector V are acquired by solving ux, uy, uz, vx, vy, and vz from Equations (7)-(12)

ux=idet*(v20*x10−v10*x20) (7)

uy=idet*(v20*y10−v10*y20) (8)

uz=idet*(v20*z10−v10*z20) (9)

vx=idet*(−u20*x10+u10*x20) (10)

vy=idet*(−u20*y10+u10*y20) (11)

vz=idet*(−u20*z10+u10*z20) (12)

The equations are based on the following conditions:

v10=v1−v0,

v20=v2−v0,

x10=x1−x0,

x20=x2−x0,

y10=y1−y0,

y20=y2−y0,

z10=z1−z0,

z20=z2−z0,

det=u10*v20−u20*v10, and

idet=1/det

The normal is calculated simply as an exterior product of two independent vectors on a plane defined by the three points.

The method for calculating a longitudinal relative direction θ is explained referring to FIGS. 19A and 19B. A vector B of the direction vector indicative of the point of sight or the light source projected on the model plane is acquired. A direction vector of the point of sight or the light source D=(dx, dy, dz), a normal vector of the model plane N=(nx, ny, nz), and the vector of the direction vector D projected on the model plane B=(bx, by, bz) are calculated by:

B=D−(D−N)*N (13)

The equation (13) is represented by elements as shown below.

bx=dx−αnx,

by=dy−αny,

bz=dz−αnz, and

α is equal to dx*nx+dy*ny+dz*nz, and the normal vector N is a unit vector.

The relative directions of the point of sight and the light source are acquired from the vector B, the vector U, and the vector V as described below.

An angle between the vector U and the vector V λ and an angle between the vector U and the vector B θ are calculated by

λ=arccos (U·V/(|U|*|V|)) (14)

θ=arccos (U·B/(|U|*|B|)) (15)

If there is no distortion in the projected coordinate system, U and V are orthogonal, i.e., λ is π/2 (90 degrees). If there is a distortion, λ is not π/2. However, if there is the distortion in the projected coordinate system, a correction is required because the texture is acquired using the directions of the point of sight and the light source relative to the orthogonal coordinate system. The angles of the relative directions of the point of sight and the light source need to be properly corrected according to the projected UV coordinate system. The corrected relative direction θ′ is calculated using one of the following. Equations (16)-(19):

Where θ is smaller than π and θ is smaller than λ;

θ′=(θ/λ)*π/2. (16)

Where θ is smaller than π and θ is larger than λ;

θ′=π−((π−θ)/(π−λ))*π/2. (17)

Where θ is larger than π and θ is smaller than π+λ;

θ′=2π−((2π−θ)/(π−λ))*π/2. (18)

Where θ is larger than π and θ is larger than π+λ;

θ′=2π−((2π−θ)/(π−λ))*π/2. (19)

The longitudinal relative directions of the point of sight and the light source to the rendering primitive are acquired as described above.

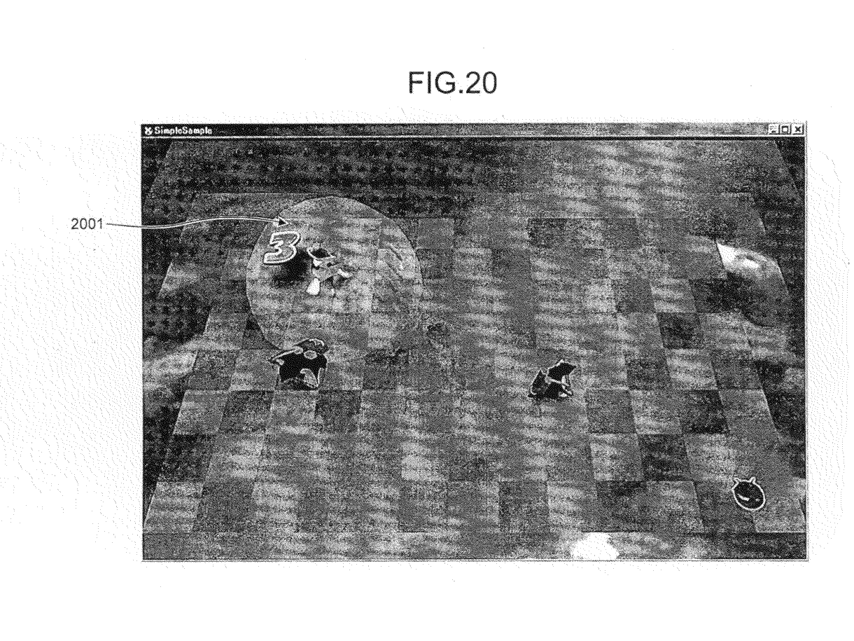

The 3D-image rendering unit 1405 renders the texture mapping in the masked-area by performing the process described above. An example of the image of the tomato bomb crashed against the real transparent cup with the visual reality created by the process is shown in FIG. 20. The masked-area is denoted by 2001.

Moreover, the 3D-image rendering unit 1405 renders a lens effect and a zoom effect to the masked-area. For example, the real-object-attribute specifying unit 1406 specifies the refractive index, the magnification, or the color of a plate used as the real object.

The 3D-image rendering unit 1405 scales the rendered image of only the virtual object centered on the center of the masked-area detected at the step S13 in FIG. 15, and extracts the masked-area as a mask, whereby scaling the scene through the real object.

By scaling the rendered image of the virtual scene centered on a pixel on which a straight line that runs through the three-dimensional zoom center on the real object and the visual point intersects with the screen 703, a digital zoom effect that uses the real object to resemble a magnifying glass is realized.

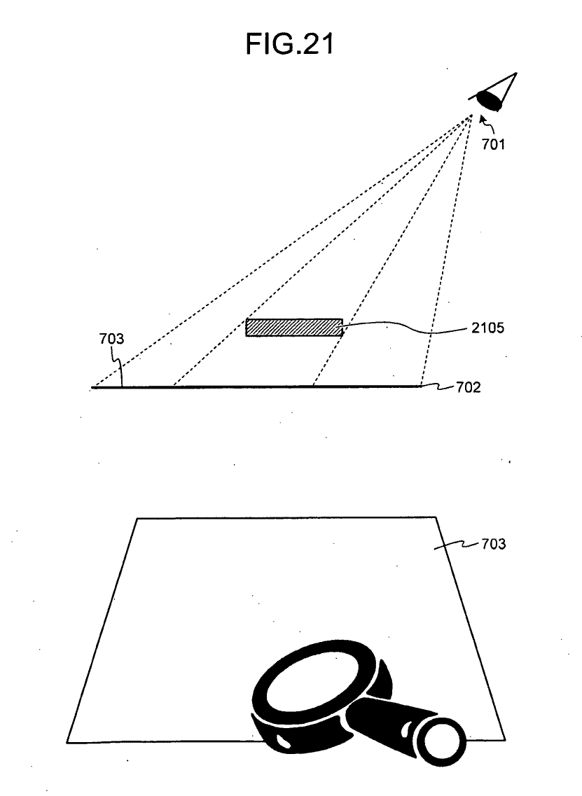

To explain the positional relation between the flat-laid stereoscopic display panel and the plate, as shown in FIG. 21, a virtual object of the magnifying glass can be superposed in the space that contains a real plate 2105, whereby increasing the reality of the stereoscopic image.

The 3D-image rendering unit 1405 can be configured to render the virtual object based on a ray tracing method by simulating refraction of abeam defined by the position of each pixel. This is realized by the real-object-shape specifying unit 101 specifying the accurate shape of the three-dimensional lens for the real object, such as a concave lens or a convex lens, and the real-object-attribute specifying unit 1406 specifying the refractive index as the attribute of the real object.

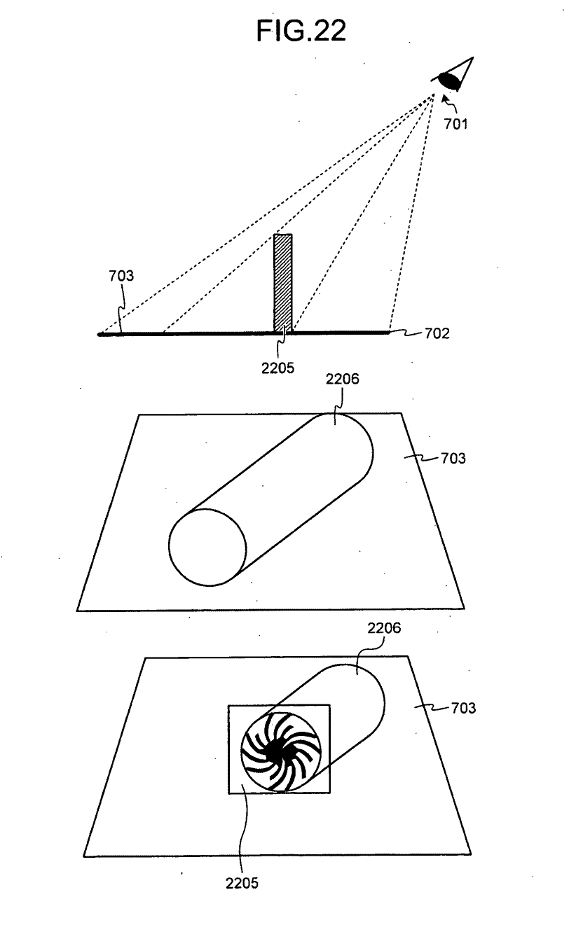

The 3D-image rendering unit 1405 can be configured to render the virtual object, so that a cross-section thereof is visually recognized, by arranging the real object. An example that uses a transparent plate as the real object is explained below. The positional relation among the flat-laid stereoscopic display panel 702, a plate 2205, and a cylindrical object 2206 that is the virtual object is shown in FIG. 22.

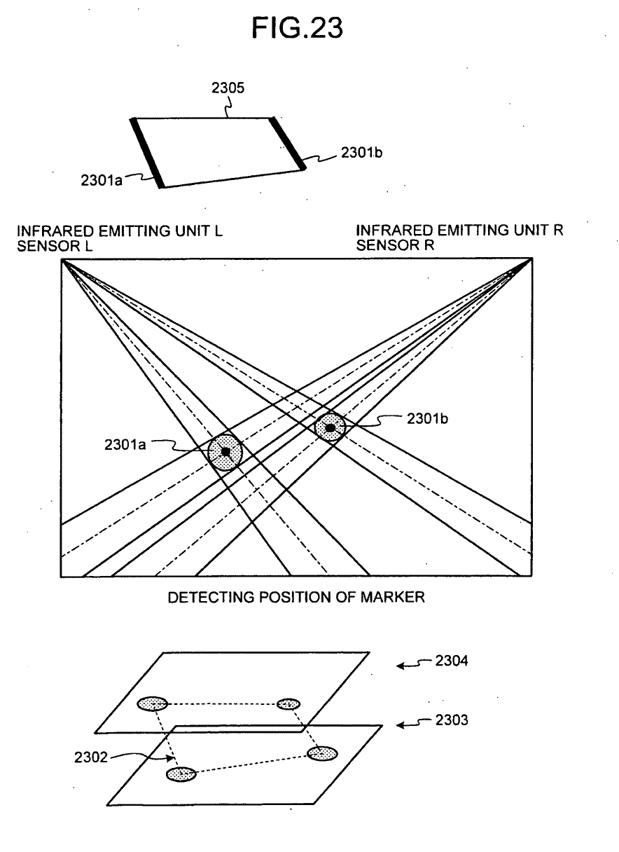

More specifically, as shown in FIG. 23, markers 2301a and 2301b for detection are applied to both ends of a plate 2305, which are frosting lines. The real-object position/posture detecting unit 103 is formed by arranging at least two each of the infrared emitting units L and R and the area image sensors L and R in layers in the height direction of the screen. In this manner, the position, the posture, and the shape of the real plate 2305 can be detected.

In other words, the real-object position/posture detecting unit 103 configured as above detects the positions of the markers 2301a and 2301b as explained in the first embodiment. By acquiring the positions of the corresponding marker from the results detected by the infrared emitting units L and R and the area image sensors L and R, the real-object position/posture detecting unit 103 identifies the three-dimensional shape and the three-dimensional posture of the plate 2305, i.e., the posture and the shape of the plate 2305 are identified as indicated by a dotted line 2302 from two results 2303 and 2304. If the number of the markers is increased, the shape of the plate 2305 is calculated more accurately.

The masked-area calculating unit 104 is configured to determine an area of the virtual object sectioned by the real object in the computation of the masked-area in the depth direction at the step S14. In other words, the masked-area calculating unit 104 refers to the relation among depth information of the real object Zobj, front-depth information of the virtual object from the point of sight Zscene_near, and back-depth information of the virtual object from the point of sight Zscene_far, and determines whether Zobj is located between Zscene_near and Zscene_far. The Z-buffer generated by rendering is used to calculate the masked-area in the depth direction from the point of sight as explained in the first embodiment.

The 3D-image rendering unit 1405 performs the rendering by rendering the pixels in the sectioned area as the volume data. Because the three-dimensional information of the sectional plane has been acquired by calculating the two-dimensional position seen from each point of sight, i.e., the information of the beam and the depth from the point of sight, as the information of the sectioned area, the volume data is available at this time point. The 3D-image rendering unit 1405 can be configured to set the pixels in the sectioned area brighter so that they can be easily distinguished from other pixels.

Tensor data that uses vector values instead of scalar values is used to, for example, visualize blood stream in a brain. When the tensor data is used, an anisotropic rendering method can be employed to render the vector information as the volume element of the sectional plane. For example, anisotropic reflective brightness distribution used to render hair is used as a material, and a direction-dependant rendering is performed based on the vector information, which is volume information, and point of sight information from the camera. The user senses the direction of the vector by the change of the brightness and the color in addition to the shape of the sectional plane of the volume data by moving his/her head. If the real-object-shape specifying unit 101 specifies a real object with thickness, the shape of the sectional plane is not flat but stereoscopic, and the tensor data can be visualized more efficiently.

Because the scene that includes the virtual object seen through the real object changes depending on the point of sight, the point of sight of the user needs to be tracked to realize the visual reality according to the conventional technology. However, the stereoscopic display apparatus 1400 according to the second embodiment receives the specified attribute of the real object and applies various surface effects to the masked-area based on the specified attribute, the shape, and the posture to generate the parallax-synthesized image. As a result, the stereoscopic display apparatus 1400 generates the stereoscopic image that changes depending on the position, the posture, and the shape of the real object without using a tracking system for the motion of the user, and efficiently generates the stereoscopic image with more real surface effect with reduced amount of the process.

In other words; according to the second embodiment, the area masked by the real object and the virtual scene through the real object are specified and rendered in advance with respect to each point of sight of the camera required to generate the stereoscopic image. Therefore, the stereoscopic image is generated independent of the tracked point of sight of the user, and it is accurately reproduced on the stereoscopic display panel.

A stereoscopic-image generating program executed in the stereoscopic display apparatuses according to the first embodiment and the second embodiment is preinstalled in a read only memory (ROM) or the like.

The stereoscopic-image generating program can be recorded in the form of an installable of executable file recorded in a computer-readable recording medium such as a compact disk read only memory (CD-ROM), a flexible disk (FD), a compact disk recordable (CD-R), or a digital versatile disk (DVD) to be provided.

The stereoscopic-image generating program can be stored in a computer connected to a network such as the Internet and provided by downloading it through the network. The stereoscopic-image generating program can be otherwise provided or distributed through the network.

The stereoscopic-image generating program includes each of the real-object position/posture detecting unit, the real-object-shape specifying unit, the masked-area calculating unit, and the 3D-image rendering unit, and the real-object-attribute specifying unit as a module. When the CPU reads and executes the stereoscopic-image generating program from the ROM, the units are loaded into a main memory device, and each of the units is generated in the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An apparatus for generating a stereoscopic image, comprising:
a detecting unit that detects at least one of a position and a posture of a real object located on or near a three-dimensional display surface;
a calculating unit that calculates a masked-area where the real object masks a ray irradiated from the three-dimensional display surface, based on at least one of the position and the posture; and
a rendering unit that renders a stereoscopic image by performing different rendering processes on the masked-area from rendering processes on other areas.

2. The apparatus according to claim 1, further comprising a first specifying unit that receives a specification of a shape of the real object, wherein
the calculating unit calculates the masked-area further based on specified shape.

3. The apparatus according to claim 2, wherein the rendering unit renders the masked-area with volume data in a three-dimensional space.

4. The apparatus according to claim 2, wherein the rendering unit renders an area around the real object in the masked-area with volume data in a three-dimensional space.

5. The apparatus according to claim 2, wherein the rendering unit renders an area of a concave portion of the real object in the masked-area with volume data in a three-dimensional space.

6. The apparatus according to claim 2, further comprising a second specifying unit that receives a specification of an attribute of the real object, wherein
the rendering unit performs different rendering processes on the masked-area from rendering processes the other areas, based on specified attribute.

7. The apparatus according to claim 6, wherein the attribute is at least one of thickness, transparency, and color of the real object.

8. The apparatus according to claim 6, wherein the rendering unit performs the rendering process on the masked-area based on the specified shape.

9. The apparatus according to claim 7, wherein the rendering unit performs a rendering process that applies a surface effect on the masked-area based on the specified attribute.

10. The apparatus according to claim 7, wherein the rendering unit performs a rendering process that applies a highlight effect on the masked-area based on the specified attribute.

11. The apparatus according to claim 7, wherein the rendering unit performs a rendering process that applies a crack on the masked-area based on the specified attribute.

12. The apparatus according to claim 7, wherein the rendering unit performs a rendering process that maps texture to the masked-area based on the specified attribute.

13. The apparatus according to claim 7, wherein the rendering unit performs a rendering process that scales the masked-area based on the specified attribute.

14. The apparatus according to claim 7, wherein the rendering unit performs a rendering process of displaying a cross section of the real object with respect to the masked-area based on the specified attribute.

15. A method of generating a stereoscopic image, comprising:
detecting at least one of a position and a posture of a real object located on or near a three-dimensional display surface;
calculating a masked-area where the real object masks a ray irradiated from the three-dimensional display surface, based on at least one of the position and the posture; and
rendering a stereoscopic image by performing different rendering processes on the masked-area from rendering processes on other areas.

16. A computer program product comprising a computer-usable medium having computer-readable program codes embodied in the medium that when executed cause a computer to execute:
detecting at least one of a position and a posture of a real object located on or near a three-dimensional display surface;
calculating a masked-area where the real object masks a ray irradiated from the three-dimensional display surface, based on at least one of the position and the posture; and
rendering a stereoscopic image by performing different rendering processes on the masked-area from rendering processes on other areas.
